(19) United States
(12) Patent Application Publication
(10) Pub. No.: US 2004/0075293 A1
(43) Pub. Date: Apr. 22, 2004

(54) Multiple operational platforms for all terrain vehicles

(76) Inventor: Abolfazl Khavari, Tannersville, PA (US)

Correspondence Address: FOSTER, SWIFT, COLLINS & SMITH, P.C., 313 SOUTH WASHINGTON SQUARE, LANSING, MI, 48933, US

(21) Appl. No.: 10/656,739

(22) Filed: Sep. 5, 2003

Related U.S. Application Data
(60) Provisional application No. 60/408,675, filed on Sep. 6, 2002.

(51) Int. Cl. B60J 11/00

(52) U.S. Cl. 296/136.01

(57) ABSTRACT

An all terrain vehicle including a front bulkhead attached to a forward area of the vehicle and a canopy frame connected to a forward region of the vehicle, forward of a driver and extending upward from the vehicle. A retractable shield may be connected to the front bulkhead, the shield being moveable from a collapsed position, wherein the shield is substantially horizontal, and a retracted position. Optional features of the present invention increase its utility and function including covers for camouflage, weather, mine sweeping, and a sleeping unit.

### CROSS-REFERENCE TO RELATED APPLICATION

This application claims priority to U.S. Provisional Application Serial No. 60/408,675 titled, “Multiple Operational Platforms for All Terrain Vehicles,” filed Sep. 6, 2002.

### FIELD OF THE INVENTION

The present invention relates generally to the field of accessories for use in an all terrain vehicle (ATV) or other narrow width or small sized vehicle, and in particular to multiple operational platforms for use on an ATV.

### BACKGROUND OF THE INVENTION

Narrow width vehicles such as all terrain vehicles (ATVs) have become popular over the last several years because of their ability to reach remote areas including areas with rough terrain. Although the most popular use of the ATV appears to be centered around recreational activities such as trail riding, reaching hunting locations, and the like, their potential for other multiple, practical and even military operations and transportation has not been fully developed. Such development could allow for not only additional, unknown, or even multiple uses for an ATV. To date, only ATV accessories that improve storage of various items during transport are known.

### SUMMARY OF THE INVENTION

Accordingly, the present invention provides multiple operational platforms (MOPs) for use on an all terrain vehicles (ATVs) and the like, as well as develops additional accessories or applications for use on the MOP.

In one embodiment of the present invention, an all terrain vehicle includes a front bulkhead attached to a forward area of the vehicle and a canopy frame connected to a forward region of the vehicle extending upward from the vehicle and forward of a driver. A retractable shield is connected to the front bulkhead, and the shield is moveable from a collapsed position, where it is substantially horizontal, and a retracted position, where the shield includes a section that is positioned at an incline and supported on the canopy frame forward of the driver to shield the driver from objects projected towards the vehicle.

Other features and advantages of the present invention will become more apparent to persons having ordinary skill in the art to which the present invention pertains from the following description taken in conjunction with the accompanying figures.

### BRIEF DESCRIPTION OF THE FIGURES

The foregoing advantages and features, as well as other advantages and features, will become apparent with reference to the description and figures below, in which like numerals represent like elements and in which:

FIG. 1 illustrates a perspective view of one embodiment of the multiple operational platforms for an ATV of the present invention showing the ATV in a transport mode;

FIG. 2 illustrates a perspective view of one embodiment of the multiple operational platforms for an ATV of the present invention showing the ATV having a sleep cover in place;

FIG. 3 illustrates a perspective view of one embodiment of the multiple operational platforms for an ATV of the present invention showing an optional driving cover;

FIG. 4 illustrates a perspective view of one embodiment of the multiple operational platforms for an ATV of the present invention showing an optional mine sweeper attached; and

FIG. 5 illustrates a perspective view of one embodiment of the multiple operational platforms for an ATV of the present invention showing an optional mine detector attached.

### DETAILED DESCRIPTION OF THE INVENTION

The present invention relates generally to the field of accessories for use on an all terrain vehicles (ATV) or other narrow width or small sized vehicles, and in particular to multiple operational platforms (MOPs) integrated within an ATV for use in various military or recreational activities.

It is noted that although the present invention platforms may be an added feature or accessory to a prior art ATV, in the preferred embodiment, the platform may be a fully integrated MOP. The integration of the components of this invention even at the level of manufacture, improves the overall reliability and strength of the MOP ATV. This may be particularly advantageous in the extreme environmental conditions encountered during military operations. As an additional feature (not shown) the powertrain for the present invention may be configured for gasoline, diesel, or jet fueled internal combustion engines known in the art.

The multiple and various accessories or attachments included with the MOP improve an ATV's usefulness such as in military applications. For example, an ATV integrating the MOP may be used as a one person transporter, a one person shelter, or an anti-personnel mine detector, and/or mine detonator. The addition of an optional cover (canopy) may turn the MOP ATV into a covered (enclosed) one person personnel transporter.

The MOP of the present invention would also allow for the introduction of additional uses of an ATV and like vehicles for sportsmen, hunters, campers, and outdoors enthusiasts, as well as park services, border patrols, forestry services, oil field and mining operations, or any remote area that requires visual inspection using a variety of specialized tools or attachments. The MOP may also attach and provide a “launch platform” for an unmanned military device (or robot). A robot can be a smaller unmanned vehicle having remote or radio control. The MOP provides the robot with capabilities, accessories and applications similar to the manned versions, but are primarily designed to go into areas too dangerous or uncertain for the soldiers or personnel to safely enter.

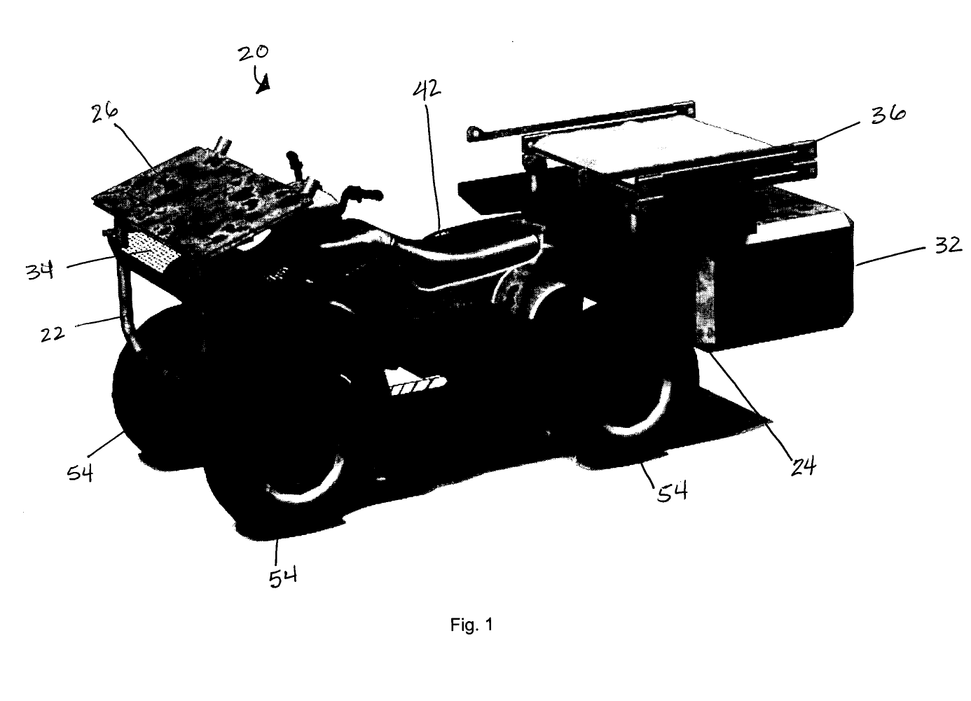

A key feature of the MOP provides for the integration of several accessories or applications to the ATV or small vehicle. As illustrated in FIG. 1, an ATV is generally indicated at 20 with one embodiment of a multiple operational platform integrated into the ATV chassis. Wheels 54, shown in the figures, may include the “run-flat” variety well known in the art. As shown, this embodiment has a reinforced front bulkhead 22 attached to a forward area of the ATV, and a reinforced rear bulkhead 24 attached to a rearward area of the ATV that allow the MOP to receive the attachments necessary to accomplish needed or desired applications or tasks.

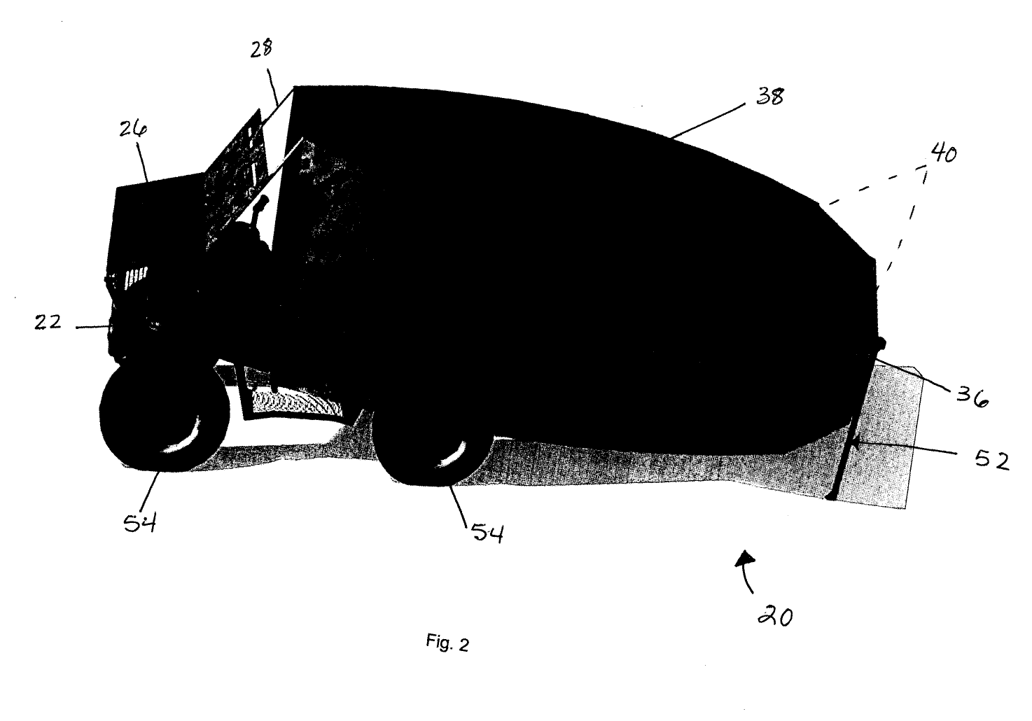

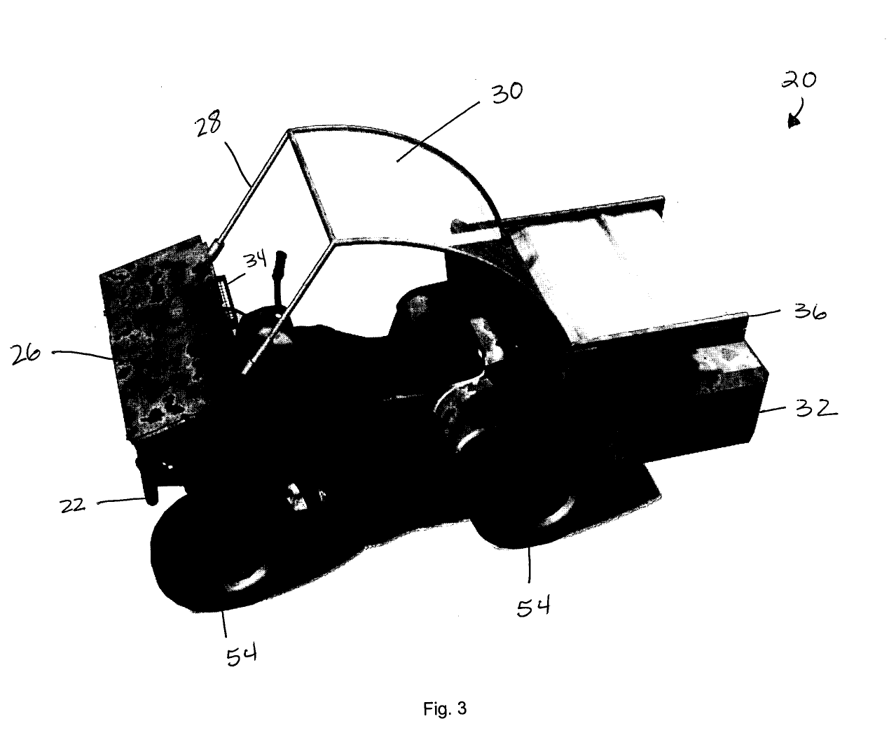

As illustrated in FIG. 1, the front bulkhead 22 includes a retractable shield 26 shown in a retracted position and designed to protect its operator from small firearms and projectiles in military applications. FIGS. 2, 4, and 5 show the retractable shield 26 in an extended position, where the extended section rests against an optional canopy frame 28. A driving canopy 30 may also be included as shown in FIG. 3. Driving canopy 30 may be made of a camouflaged material or any other desired color or fabric. A front tray attachment 34 may also be connected to the front bulkhead 22 to use for holding various objects.

The figures also illustrate various features that may be attached to the rear bulkhead 24. A storage box 32, a retractable/collapsible sleeper unit 36, and a cover 38 may be attached at a rear area of the ATV as shown in FIGS. 1 and 2. FIG. 2 illustrates the sleeper unit 36 extended rearwardly from the ATV 20 and the cover 38 attached to sleeper unit 36. An internal frame 40 is used to support cover 38 above sleeper unit 36. Cover 38 is also attached at the front of ATV to canopy frame 28. The sleeper unit 36 may be up to 2.134 meters (7 feet) long and can fold out rearward of the ATV using various slide out/telescope devices known in the art. Support legs 52 may be connected to sleeper unit 36 to support sleeper unit 36 in the extended position. Sleeper unit 36 may be stored in a retracted position behind the driver seat 42. The sleeper unit 36 may include an attached self-inflating air mattress and an all weather blanket/sleeping bag.

The sleeper cover 38 may be used to protect the operator from adverse weather conditions, and may optionally include screen material known in the art to protect against insects. An optional camouflage pattern of cover 38 would allow the MOP equipped ATV to blend in with the surrounding environment, and make it harder for an enemy to identify (or for an animal to spot in hunting applications).

Likewise, the optional driving canopy 30 may provide limited protection from the elements by protecting the operator from excessive sun or rain. A camouflage pattern of canopy 30 allows the ATV to blend in with its surrounding environment, thus making it, for example, harder to be detected by the enemy in military applications.

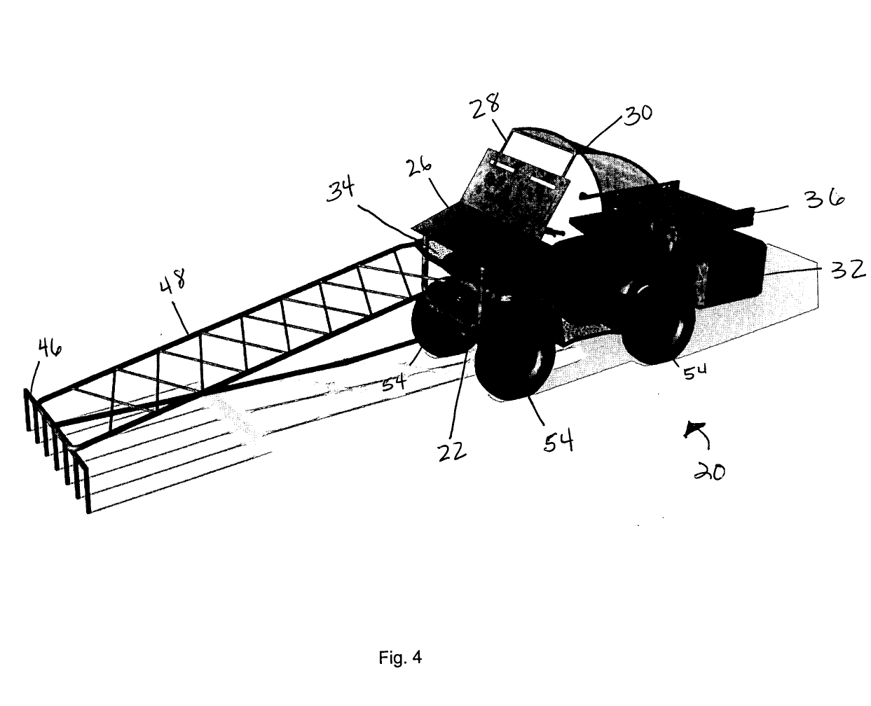

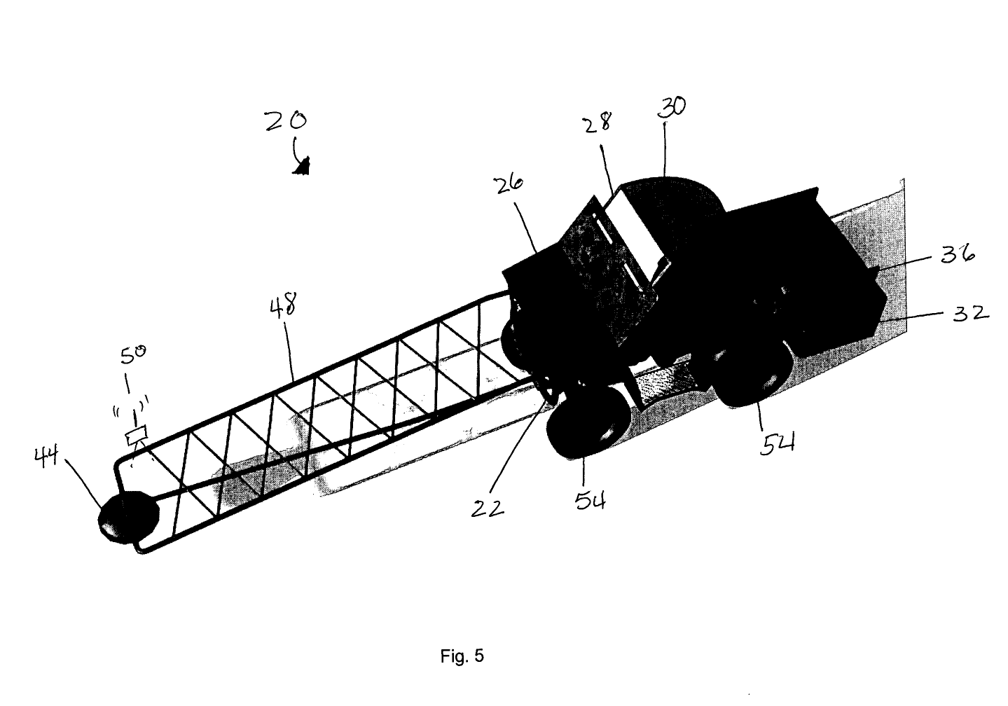

FIGS. 4 and 5 show an optional mine detector 44 (FIG. 5) and mine sweeper 46 (FIG. 4) that may be connected to front bulkhead 22. To accomplish mine detecting and sweeping, a boom 48, such as a 3.048 meter (10 foot) long detachable and collapsible arm and metal/mine detector/sensor head can be attached to the front bulkhead 22. When not in use, the mine detector 44 and mine sweeper 46 or other such device may be stored in the storage box 32.

The multiple operational platforms equipped ATV may also include a remote controlled paint sprayer 50 that may be connected to boom 48 and configured to “mark” or “flag” the area to be cleaned by the mine sweeper or avoided by friendly forces. When an ATV is equipped with the boom 48 and mine sweeper 46 and/or mine detonator 44 and shield 26 is fully deployed (extended), the ATV may clean up paths from anti-personnel mines, and reduce the opportunity for injuries to personnel and equipment.

Other optional features of the present invention may include a Global Positioning System (GPS), wireless radio controls, audio/video equipment, and use of satellite technologies, all of which allow the MOP equipped ATV to be the “Eyes & Ears” for communication command and control. The ATV can also be equipped with a self-inflatable “dummy” that would resemble a live operator on the driver seat, and using an on board GPS, radio controls as well as an audio/video system, the MOP equipped ATV could be sent into enemy territories via remote operation as a decoy to fool the enemy into drawing fire, thus identifying and pinpointing the enemy's location. Friendly forces can then proceed to secure the area for future use.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

The invention claimed is:

1. An all terrain vehicle, comprising:
a front bulkhead attached to a forward area of the vehicle; and
a canopy frame connected to a forward region of the vehicle extending upward from the vehicle and forward of a driver.

2. The all terrain vehicle of claim 1, further comprising:
a retractable shield connected to the front bulkhead, said shield moveable from a collapsed position, wherein said shield is substantially horizontal, and a retracted position, wherein said shield includes a section that is positioned at an incline and supported on said canopy frame forward of the driver to shield the driver from objects projected towards the vehicle.

3. The all terrain vehicle of claim 2, wherein said shield is camouflaged.

4. The all terrain vehicle of claim 2, further including a rear bulkhead mounted to a rear area of the vehicle.

5. The all terrain vehicle of claim 4, further including a storage unit attached to said rear bulkhead.

6. The all terrain vehicle of claim 4, further including a collapsible sleeper unit attached to a rear area of the vehicle.

7. The all terrain vehicle of claim 6, wherein said sleeper unit is moveable from a collapsed position, wherein said sleeper unit is substantially horizontal and an extended position, wherein said sleeper unit extends rearwardly of said rear bulkhead and is supported by at least one support leg.

8. The all terrain vehicle of claim 1, further including a driving canopy connected to said canopy frame and positioned above the driver.

9. The all terrain vehicle of claim 6, further including an internal frame connected to said rear bulkhead and extending upwardly substantially vertically from the vehicle and a sleeper cover connected to said canopy frame and said internal frame, said sleeper cover configured to conceal an occupant of said sleeper unit.

10. An all terrain vehicle, comprising:
a front bulkhead connected to a forward area of the vehicle;
a boom connected to said front bulkhead and extending forward of the vehicle; and
a mine detector connected to said boom.

11. An all terrain vehicle, comprising:
a front bulkhead connected to a forward area of the vehicle;
a boom connected to said bulkhead and extending forward of the vehicle; and
a mine sweeper connected to said boom.
